(19) United States
(12) Patent Application Publication
(10) Pub. No.: US 2002/0152177 A1
(43) Pub. Date: Oct. 17, 2002

(54) Method and arrangement for electronically transferring an amount of money from a credit account memory

(76) Inventor: Hans-Hermann Wolf, Muenchen (DE)

Correspondence Address: BELL, BOYD & LLOYD, LLC, P. O. BOX 1135, CHICAGO, IL, 60690-1135, US

(21) Appl. No.: 10/110,665

(22) PCT Filed: Aug. 2, 2001
(86) PCT No.: PCT/EP01/09218

(30) Foreign Application Priority Data
Aug. 18, 2000 (EP) 00117811.0

(51) Int. Cl. G06F 17/60

(52) U.S. Cl. 705/64

(57) ABSTRACT

Method for transferring an electronic sum of money from a credit memory associated with a money sender to an account or to a credit memory associated with a money receiver via a telecommunications and data network in real time.

The invention relates to a method and to an arrangement for transferring an electronic sum of money from a credit memory to an account or to another credit memory via a telecommunications and data network.

Besides for use as a means of communication and a source of information for what has now become hundreds of millions of people, the Internet is becoming increasingly important as a source of shopping. Particularly trade in software, books and travel is already being carried out on the Internet in a significant proportion today, but also a broad spectrum of other goods and services is increasingly being ordered and paid for over the Internet. Paying for the relevant services on the Internet in the manner which was established originally and is still generally widespread today requires the relevant data records to be input separately in each case, at least by each party to the transaction, if not even for the individual transaction. This mode of payment thus allows the party to the transaction to see sensitive personal data and even to store them permanently.

The Internet has now also become considerably important for handling other payment operations in the business and private sectors. Virtually all banks in industrial states offer electronic handling of account management and of payment operations in the form of “electronic banking”.

Nevertheless, the majority of payment operations in day-to-day life are, even today, still performed using cash or by providing transfer or direct debit orders or the like in writing, or by credit card or check card.

In specific areas, for example that of mobile radio technology, electronic credits (“prepaid cards”) have also become significant, but considerable obstacles prevent this means of payment from being introduced on a widespread basis.

Altogether, it can be stated that, in the current state of development, there are an extremely confusing large number of options for paying for goods or services, and using said options in day-to-day life requires considerable alertness and requires a wide variety of media and modes of entry to be dealt with. This is demanding and is also associated with diverse security risks (losing data media or credit media, forgetting account data and authentication codes etc.).

Besides the Internet, telecommunications—in particular mobile telecommunications—today represents an area of rapid technical and economic development and a significant source of economic growth and new social developments. For many of the people in industrial states, the mobile telephone (“mobile”) is increasingly becoming a universal communication and information instrument and is also increasingly being used to access goods and services. This development is also still hindered by insufficient opportunities for reliable and at the same time simple payment for information, goods and services ordered using a mobile.

Although solutions exist which allow the user of a mobile—with or without a prepaid card—to authorize payments, which are then processed in a conventional manner by debit procedures or credit card debiting, these methods presuppose, as do payment processing procedures which have now been introduced on the Internet, that the purchaser is creditworthy and has authority to use a credit card or a current account with an overdraft facility. In addition, these procedures have inherent time lags which have an adverse effect on the transparency and reliability of the overall processing.

The invention is therefore based on the object of specifying a method and an arrangement for simplified processing of payment transactions using a data network.

This object is achieved in terms of its method aspect by a method having the features of claim 1, and in terms of its apparatus aspect by an arrangement having the features of claim 8.

The invention encompasses the fundamental concept of specifying a largely universal payment method on the basis of an electronic credit (prepaid account or card) which can be used for payment processing in the “B2C (Business-2-Consumer) sector” and also in the “C2C (Consumer-2-Consumer) sector”, that is to say allows shopping in real and virtual shops, payment in catering or cultural establishments, at vending machines etc., and the “transfer” of sums of money in the private sector. It also encompasses the concept of using the opportunities of a combined telecommunications and data network in this regard, specifically the opportunity for processing in real time, in particular.

In the present case, an electronic credit is understood to mean a memory content of a credit memory which can be operated via a telecommunications or data network in order to perform payment transactions—in principle regardless of whether the memory actually has a prepaid credit or whether a credit sum is not transferred until a later time.

The central piece in the proposed arrangement and in the proposed method is a transaction server which accesses a transaction database storing the data relevant for transferring prepaid credits. The transfer operation is initiated by the money sender calling a call number for the money receiver which has been set up specifically for this purpose. This call number is stored in the transaction data base and is used, to a certain extent, as an address for a money receiver data record which is relevant to the money transfer operation.

A fundamental feature of one preferred embodiment of the invention is that the sum of money to be transferred is input by the money sender on his terminal. This can also be done in the second phase of a procedure in which the call number of the money sender is first input and dialed, and the money sender is asked by means of an announcement or menu guidance to input the sum of money. He then makes the relevant input in response to this request.

A “switch” associated with the money sender—specifically a trigger in the HLR (Home Location Register) in a mobile radio network—sends a request to a server (e.g. the SCP=Service Control Point in an intelligent network) regarding the way in which this call is to be performed. The call number reveals that this is not a normal call to the subscriber, but rather a special call for processing a money transfer. This specification can be encrypted in a section of the call number or becomes clear from the fact that the server “tests” access to the transaction data base and this access is successful.

As a real time method, the proposed method affords improved transparency and reliability as compared with known payment processing methods and can also be used, in particular, by people who have not been granted a credit facility. The user need merely have a prepaid credit ensuring sufficient coverage of the envisaged money transfer.

In the description below and in the patent claims, the holder of the prepaid credit who wishes to transfer a sum of money and is in a (real or virtual) shop as a purchaser and in a catering establishment as a guest is referred to generally as the “money sender”. The receiver of the sum of money to be transferred, who will usually be the owner or operator of a shop or of a catering or cultural establishment or like in daily life, is referred to generally as the “money receiver” below. In addition, the money receiver and the money sender may also be applications.

Any money receiver wishing to use the option of transferring money from prepaid credits associated with a party to his own account needs to subscribe to a service which implements the money transfer. The subscription process involves a data record relating to said money receiver being stored in the transaction data (“shopping database”). The money receiver's account needs to be suitable for managing electronic credits; it can likewise be a prepaid account, in particular. The money receiver can use a plurality of telephone numbers and also a plurality of destination accounts for the transfer of money, in which case all the telephone numbers to be used and account identifiers for all the accounts naturally need to be stored in the shopping database. (The term “account identifier” is understood below to mean an account number or an account code and the possibly required server address of an external server on which the account is managed, as a whole.) Besides the aforementioned data, the money receiver data record stored in the transaction database expediently also comprises a name or company name.

Besides the information relating to the money receiver, the shopping database preferably also contains the information about the money sender which is required for performing the money transfer. This money sender data record expediently contains the account number of his prepaid account and, if required, the server address of an external server on which the prepaid credit is managed (also occasionally referred to in the present case as “account identifier” below), advantageously also the server and operator names and, finally, an authentication data record for authenticating larger money transfers at least optionally on a case by case basis. The “address” or “key” used for this data record is expediently the money sender's call number.

The money sender data record can also be stored in a separate prepaid database.

A fundamental security component is the aforementioned authentication data record within the money sender data record. The authentication data record comprises, in particular, an authentication code (PIN or the like) and/or biometric data for the money sender (e.g. papillary line or retina pattern), which code and data are used for authorizing money transfers on a case-by-case basis. This code and these data are input on the money sender's terminal or on an input unit associated therewith, are transmitted to the transaction server and are compared there with the corresponding stored data. As a result of the comparison, the transaction is enabled or blocked.

In one preferred implementation of the method the aforementioned authorization steps are not performed for very small sums, but only for sums of money which exceed a predetermined threshold value. This threshold value can advantageously be set and changed by the service provider or the money sender himself.

The proposed solution, which, symbolically, can also be referred to as a “prepaid shopping application”, comprises the function blocks (1) start the money transfer procedure, (2) debit the money sender and (3) credit the money receiver. These function blocks can be executed on one and the same server or on different servers, which is/are collectively referred to by the term “transaction server”. The server or servers can exist centrally with a service provider or in a plurality of hardware implementations with this service provider or else with a plurality of service providers. The prepaid shopping application has—as already mentioned above—access to a “shopping database” which (according to the specific network and application concept) can likewise be provided centrally at one point, distributed over a plurality of points or else in a plurality of copies at various points.

The method and arrangement are in the simplest form when the money sender's prepaid credit, the money receiver's destination account and the prepaid shopping application itself are managed or operated with one and the same service provider. If this is not the case, clearing (known as such) needs to take place for the money transfer. For this process, the documentation produced for the debiting and crediting process, particularly in the form of “log records”, can be used.

The proposed system affords the considerable advantage (in addition to the advantages already described) that the electronic money held in a prepaid account can be used not only for paying for a service having a narrow specification (specifically telephone calls), but also in diverse ways for paying for goods, service, information etc. in real or in virtual sales establishments of all kinds. Prepayment of the credit gives the user strict cost control, and in principle it is not possible to get into debt unintentionally. This means that this method can be used with particular advantage for minors (or else for older people who are no longer in full possession of their mental faculties) as well, for whom there has been no comparable application to date. For paying for goods and services from different suppliers, the money receiver is no longer requires a plurality of prepaid cards or terminals, but rather only need store a single prepaid call number.

Advantages and expediencies of the invention can otherwise be found in the subclaims and in the description below of a preferred exemplary embodiment with reference to the figures, in which:

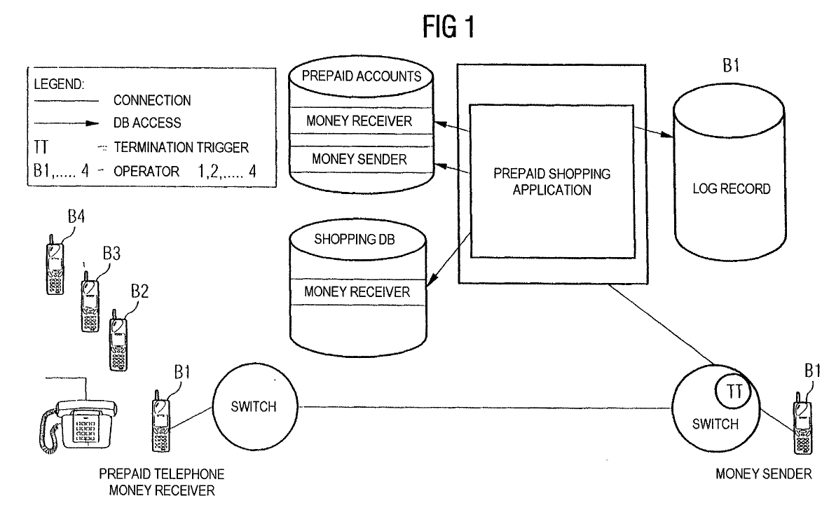

FIG. 1 shows a greatly simplified function block diagram of a first embodiment of the inventive arrangement,

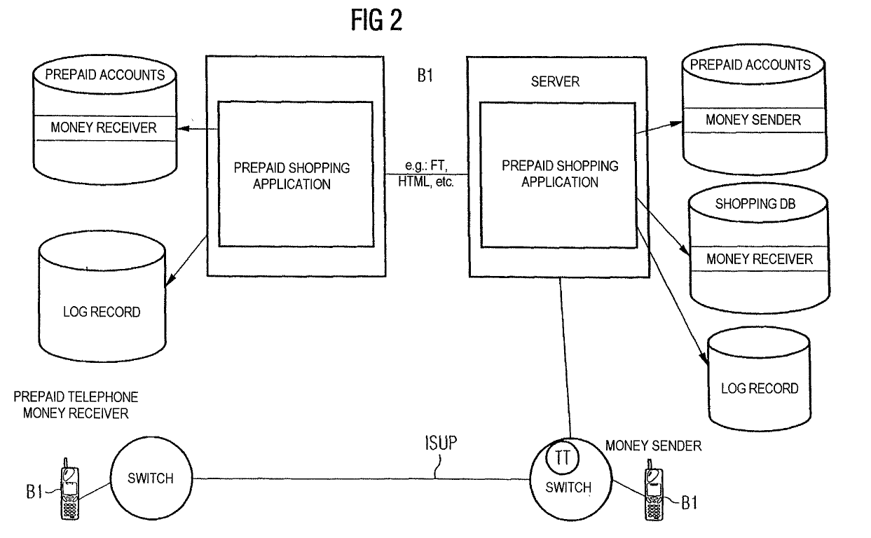

FIG. 2 shows a greatly simplified function block diagram of a second embodiment of the arrangement according to the invention, and

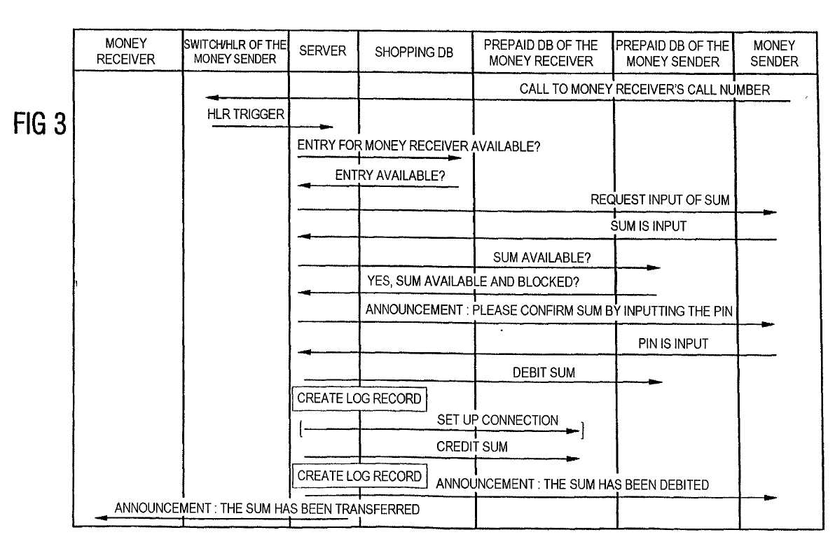

FIG. 3 shows a schematic illustration of the fundamental steps in the proposed application for the arrangement shown in FIG. 1.

The labeling in the figures makes them fundamentally self-explanatory, so that no detailed description of the figures is given below.

It should be pointed out that, in FIG. 1, the assumption is made that the prepaid shopping application, runs on the same server as that on which prepaid accounts of the money receiver and money sender are managed. By contrast, FIG. 2 shows the situation in which prepaid accounts of the money sender and money receiver are managed on a different server than that on which the prepaid shopping application is running.

A fundamental feature of the proposed method is the availability of a special transaction call number for any desired telecommunications terminal associated with any desired operator (conventional telephone or telephone with a prepaid card in a mobile radio network or in the landline network) for the money receiver. The call number is allocated specifically for money transfers and cannot be used for normal detailed telephone calls. It is assigned to the money receiver within the context of a subscription to a money transfer service offered by a service provider. The call number is stored in a transaction database SHOPPING DB as a specific money receiver call number. (In FIG. 1, the references B1 to B4 indicate that the money receiver can hold a plurality of transactions or prepaid call numbers with various operators.)

The money transfer operation is initiated by the money sender calling the transaction call number of the money receiver. In this case, for example following the call number—separated therefrom by a star (*)—the sum of money to be transferred in the relevant currency is input as an unstructured digit sequence on the money sender's terminal. This is done using its keypad, in particular; in principle, voice input is also possible within the context of appropriately designed menu guidance, however. It is also possible for the sum of money to be input not by the caller, but rather—at a suitable point in the overall procedure at which there is an appropriate connection to the transaction server—by the respective party to the transaction.

When the money sender terminal is in the form of a mobile telephone, as assumed in the present case, a trigger in the HLR in the mobile radio network is used to make a request to the server—especially implemented in a SCP in the mobile radio network—regarding the form of the call which has been initiated. The server uses the money receiver's transaction call number to access the shopping database and looks for an entry corresponding to the call number. If an entry is found, the call has been specified as a call for processing a money transfer, and appropriate checks and subsequent actions are initiated.

When the data have been transmitted, which means that the money transfer procedure has been started, a checking process is first carried out to determine whether the data medium is valid and whether the sum in the money sender's prepaid account is sufficient for the envisaged transfer process. If both are the case, the money sender is asked to input his PIN in order to authorize the debit operation on the sum of money to be transferred.

The checking process involves the prepaid shopping application accessing the shopping database and reading the money receiver data record and the money sender data record with the information contained therein regarding which server or which servers (and which operator or which operators) hold the accounts of the money receiver and the money sender. The server belonging to the money sender is identified and, if it is a server other than that on which the prepaid shopping application is running, a real time connection to a prepaid shopping application running on this foreign server is set up.

The prepaid shopping application on the money sender's server is sent a request to check whether the electronic credit in the money sender's prepaid account is sufficient for the envisaged money transfer. If this is not the case, the transfer is terminated with a corresponding advice signal to the terminal of the money sender and/or money receiver. If the sum of money to be transferred is covered, it is reserved in the money sender's prepaid account.

The aforementioned authorization is then given by virtue of the money sender inputting the PIN on his terminal, possibly using SMS or the like. The PIN which is input is compared with the PIN stored in the money sender data record. If it is valid, the debiting process is initiated. If it is not valid, the transaction is terminated at this point and a corresponding advice signal is again transmitted.

The sum of money to be transferred is then debited from the money sender's prepaid account. This process is time critical and is performed in real time. If the money sender's prepaid account is on the same server as the prepaid shopping application, the credit can immediately (in real time) be reduced by the sum of money to be transferred. If the account is on a foreign server, the debit request needs to be made to the prepaid shopping application on that server, and the debit operation is performed under that application's regime. In each case, a log record is produced for the debiting process, and the money receiver is informed about the debit operation having been performed by means of the cash register system or a call or by SMS or the like.

The sum of money to be transferred is then credited to the money receiver's account, which can be a prepaid account, a real time account or a normal bank current account. This process is not time critical but needs to take place with the utmost reliability. In this case too, a distinction needs to be made between the aforementioned variants for debiting—according to whether or not the account is managed on a foreign server. A log record is also produced for the crediting process, and the money receiver and money sender can be informed immediately after this has been done.

The implementation of the invention is not limited to the aforementioned examples, variants and aspects; rather, the claims likewise permit a large number of modifications for it which are within the scope of action of a person skilled in the art. In particular, the method steps described above are also possible in a different order.

1. A method for transferring an electronic sum of money from a credit memory associated with a money sender, particularly containing a prepaid credit, to an account or to a credit memory associated with a money receiver via a telecommunications and data network, in real time, having the following steps:
the money receiver subscribes to a money transfer service with a service provider and, in so doing, stores a money receiver data record, comprising at least one transaction call number for a terminal associated with the money receiver in the telecommunications network and an account identifier for the money receiver's account or credit memory, in a transaction database,
a money sender data record, comprising at least one call number for a terminal, an account identifier for the credit memory and an authentication data record for the money sender, is stored in the transaction database or in a credit management database,
a connection is set up between the money sender's terminal and a transaction server associated with the service provider, particularly on the basis of part of the transaction call number,
the sum of money to be transferred is input on the money sender's terminal and is transmitted to the transaction server,
the transaction server reads the money receiver data record and the money sender data record from the transaction database and evaluates it/them, which includes setting up (an) optionally required data link(s) to one or more external application(s),
the coverage of the sum of money is checked in the money sender credit memory, and the sum of money is reserved if it is covered, or the process is terminated with signaling if there is insufficient coverage,
the sum of money is debited from the money sender credit memory, and this is documented,
the sum of money is credited to the money receiver account or to the money receiver credit memory, and this is documented,
information about the debit and/or credit operation is transmitted to the money receiver's terminal and in particular also to the money sender's terminal.

2. The method as claimed in claim 1,
characterized in that
the connection to the transaction server is originally set up from the money sender's terminal by dialing the transaction call number of the money receiver's terminal, and the sum of money to be transferred is input in connection with the transaction call number.

3. The method as claimed in claim 1,
characterized in that
the connection to the transaction server is originally set up from the money receiver's terminal, with the setup of a connection to the money sender's terminal being interposed and the sum of money being input on the latter.

4. The method as claimed in one of the preceding claims,
characterized in that
the authentication data record in the money sender data record comprises an authentication code and, before the debit operation step, steps for authorizing said debit operation are performed, namely the following steps:
the authentication code is input by the money sender on his terminal,
the input is transmitted to the transaction server, and
the transmitted data are compared with the data held in the money sender data record, and a debit enable signal is output if there is a match and a debit blocking signal is output if there is no match.

5. The method as claimed in claim 4,
characterized in that
the authorization steps are performed for a sum of money which exceeds a predetermined threshold value which can be set by the service provider or the money sender, in particular.

6. The method as claimed in one of the preceding claims,
characterized by
its being performed by setting up a data link to at least one external server on which the money sender credit memory and/or the money receiver account or the money receiver credit memory are managed, the account identifier of the money receiver data record and/or the account identifier of the money sender data record comprising a server address or server call number, and the transaction server being connected to this or these following the step of reading out the money receiver data record and the money sender data record in order to perform the subsequent steps.

7. The method as claimed in one of the preceding claims,
characterized in that
the money receiver takes out a subscription with the service provider using a plurality of accounts and/or call numbers, the number of accounts being less than the number of call numbers, in particular, and all the corresponding account identifiers and the call numbers being stored in the money receiver data record.

8. An arrangement for transferring an electronic sum of money from a credit memory associated with a money sender, particularly containing a prepaid credit, to an account or to a credit memory associated with a money receiver via a telecommunications and data network in real time, particularly in order to carry out the method as claimed in one of the preceding claims, which has:
at least one account management server having a money sender credit memory and a money receiver account or credit memory,
a money receiver terminal which is connected to the telecommunications and data network and has an associated special transaction call number,
a money sender terminal connected to the telecommunications and data network
a transaction database associated with a service provider, which stores a money receiver data record, comprising at least the transaction call number of the money receiver's terminal and in particular also an account identifier for the account or credit memory, and a money sender data record comprising the call number of a terminal associated with the money sender and in particular an account identifier for the credit memory, and also an authentication data record, and
a transaction server which is connected to the transaction database and can be connected to at least the money sender's terminal and to the account management server or account management servers or is an integral part of said server or servers, for reading and for evaluating the money receiver data record and the money sender data record from the transaction database, and for setting up (an) optionally required data link(s) to one or more external application(s) and for controlling a coverage check in the money sender credit memory and a debit operation on the latter and a credit operation on the money receiver account or money receiver credit memory.

9. The arrangement as claimed in claim 8,
characterized in that
the transaction database and the money sender credit memory and/or the money receiver credit memory are implemented on the transaction server.

10. The arrangement as claimed in claim 8 or 9,
characterized in that
the transaction server has means for documenting a debit operation and a credit operation, in particular in the form of a log record.

11. The arrangement as claimed in one of claims 8 to 10,
characterized in that
the transaction server has associated telecommunication means for signaling termination of a transaction or a debit operation and/or a credit operation to the money sender's terminal and in particular also to the money receiver's terminal.

12. The arrangement as claimed in one of claims 8 to 11,
characterized in that
the telecommunications and data network comprises a mobile radio network, with the money sender's terminal, in particular, being in the form of a mobile radio terminal or a data processing unit equipped with a mobile radio part.

13. The arrangement as claimed in one of claims 8 to 12,
characterized by
a plurality of terminals associated with the money receiver which are registered with the service provider and whose transaction call numbers are stored in the money receiver data record.
